(19) United States
(12) Patent Application Publication
(10) Pub. No.: US 2016/0050496 A1
(43) Pub. Date: Feb. 18, 2016

(54) DIAPHRAGM HAVING IMPROVED SURROUND STRUCTURE

(71) Applicant: MERRY ELECTRONICS (SUZHOU) CO., LTD., Suzhou City (CN)

(72) Inventor: Chia-Chi LAI, Taichung City (TW)

(21) Appl. No.: 14/459,817

(22) Filed: Aug. 14, 2014

(51) Int. Cl. H04R 7/12; G10K 13/00

(52) U.S. Cl. CPC H04R 7/12; G10K 13/00

(57) ABSTRACT

A diaphragm is formed of a central portion and a surround encircling and connected with the central portion. The surround is provided with an arc-shaped section and includes a concavity. An imaginary datum plane is defined by an external edge of the concavity. In sectional view, two ends of an external side of the surround extend away from the datum plane to intersect with each other to define an imaginary end point. The surround further includes an annular flexible portion located between the end point and the datum plane. In light of the structure disclosed above, the diaphragm can adjust the rigidity of the surround by means of the annular flexible portion to make the displacement amount of the central portion consistent with the rigidity of the diaphragm, so the speaker can output the same acoustic pressure to improve the acoustic distortion and noise that may occur potentially.

### BACKGROUND OF THE INVENTION

1. Field of the Invention

The present invention relates generally to a diaphragm of a speaker and more particularly, to a diaphragm having an improved surround structure.

2. Description of the Related Art

A surround is an essential component of a speaker, surrounding and being connected with an external edge of a central portion of the diaphragm. The central portion can be fixed to a stand or a housing of the speaker by means of the surround. The surround can secure degree of freedom of the central portion in axial direction and prevent the central portion from transversal displacement, so the frequency response and timbre of output sound of the speaker are affected to a certain degree.

A conventional speaker, especially the micro-speaker, usually includes a radial pattern imprinted by hot-press molding on a top side of the surround of the diaphragm, as shown in FIG. 1. After a simulated test is applied to the speaker shown in FIG. 1, a result an be acquired as shown in FIG. 2, in which the Y-axis denotes the rigidity of the diaphragm and the X-axis denotes the displacement amount of the central portion. The zero point on the X-axis denotes the initial position of the central portion, what's increasing rightward from the zero point on the X-axis denotes that the central portion is vibratile upwards, and what's decreasing leftward from the zero point on the X-axis denotes that the central portion is vibratile downwards. As illustrated in FIG. 2, the left and right parts of the curve centered on the zero point of the X-axis are not symmetric, thus indicating that the rigidity of the central portion being vibratile upwards is apparently greater than the rigidity of the central portion vibrated being vibratile downwards. Therefore, it is difficult for the central portion to be vibratile upward but it is easy for the central portion to be vibratile downward. Such pattern can though enhance the acoustic compliance and reduce the resonant frequency, but when the speaker outputs sound, the upward and downward acoustic pressures are inconsistent, so the sound becomes distorted and the noise may occur.

### SUMMARY OF THE INVENTION

The primary objective of the present invention is to provide a diaphragm applied to a speaker for improving the distortion and noise of the speaker.

The foregoing objective of the present invention is attained by the diaphragm formed of a central portion and a surround encircling and connected with the central portion. The surround is provided with an arc-shaped section and includes a concavity. An imaginary datum plane is defined by an external edge of the concavity. In sectional view, two ends of an external side of the surround extend away from the datum plane to intersect with each other to define an imaginary end point. The surround further includes an annular flexible portion located between the end point and the datum plane.

In light of the structure disclosed above, the diaphragm can adjust the rigidity of the surround by the annular flexible portion to make the displacement amount of the central portion consistent with the rigidity of the diaphragm in relationship while the central portion is vibrate upwards and downwards. Therefore, the speaker can output the same acoustic pressure to improve the acoustic distortion and noise that may occur potentially.

Preferably, the annular flexible portion includes a tabular, triangular, arc-shaped, or trapezoid section.

### BRIEF DESCRIPTION OF THE DRAWINGS

FIG. 1 is a perspective view of a conventional diaphragm.

FIG. 2 is a diagram of the conventional diaphragm, illustrating the relationship between the rigidity of the diaphragm and the displacement of the central portion.

FIG. 3 is a top view of a first preferred embodiment of the present invention.

FIG. 4 is a sectional view taken along a line 4-4 indicated in FIG. 3.

FIG. 5 is a diagram of the first preferred embodiment of the present invention, illustrating the relationship between the rigidity of the diaphragm and the displacement of the central portion.

FIG. 6 is a top view of a second preferred embodiment of the present invention.

FIG. 7 is a sectional view taken along a line 7-7 indicated in FIG. 6.

FIG. 8 is a diagram of the second preferred embodiment of the present invention, illustrating the relationship between the rigidity of the diaphragm and the displacement of the central portion.

FIG. 9 is a sectional view of a third preferred embodiment of the present invention.

FIG. 10 is a diagram of the third preferred embodiment of the present invention, illustrating the relationship between the rigidity of the diaphragm and the displacement of the central portion.

FIG. 11 is a sectional view of a fourth preferred embodiment of the present invention.

FIG. 12 is a diagram of the fourth preferred embodiment of the present invention, illustrating the relationship between the rigidity of the diaphragm and the displacement of the central portion.

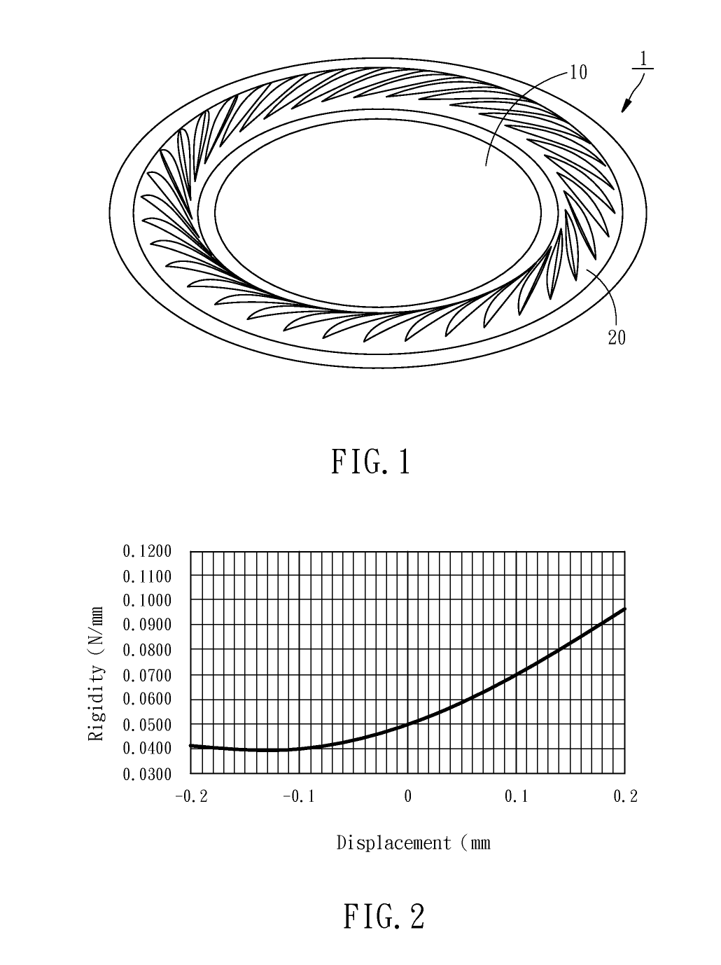

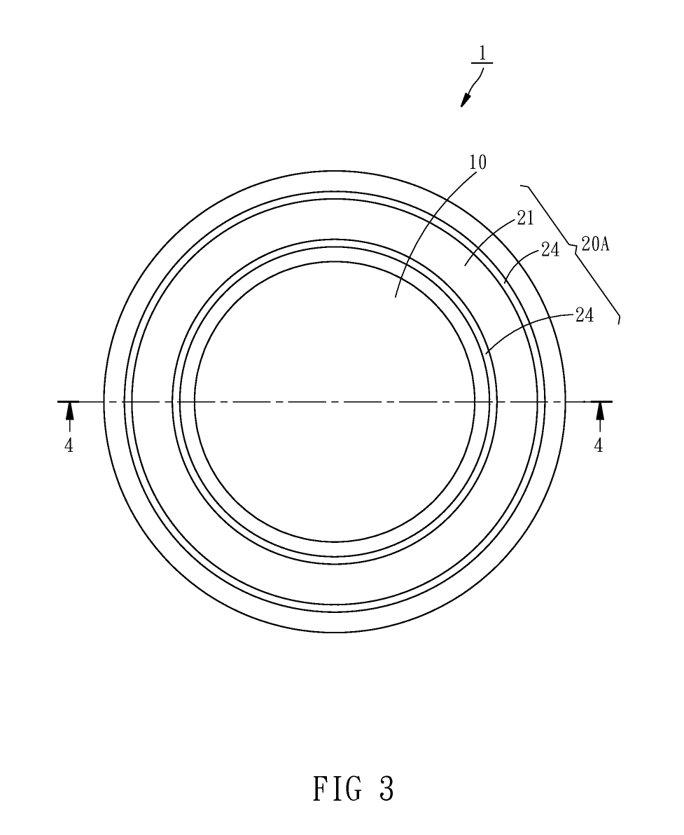

### DETAILED DESCRIPTION OF PREFERRED EMBODIMENTS

Structural features and desired effects of the present invention will become more fully understood by reference to four preferred embodiments given hereunder. However, it is to be understood that these embodiments are given by way of illustration only, thus are not limitative of the claim scope of the present invention.

Referring to FIGS. 3-5, a diaphragm 1 constructed according to a first preferred embodiment of the present invention is formed of a central portion 10 and a surround 20. The diaphragm 1 can be driven by a voice coil (not shown) and a magnetic circuit (not shown) located inside a speaker (not shown) to be vibratile upwards and downwards for generating sound. Since the voice coil and the magnetic circuit are not the key points of the present invention, more recitation thereof is omitted. The detailed descriptions and operations of these elements as well as their interrelations are recited in the respective paragraphs as follows.

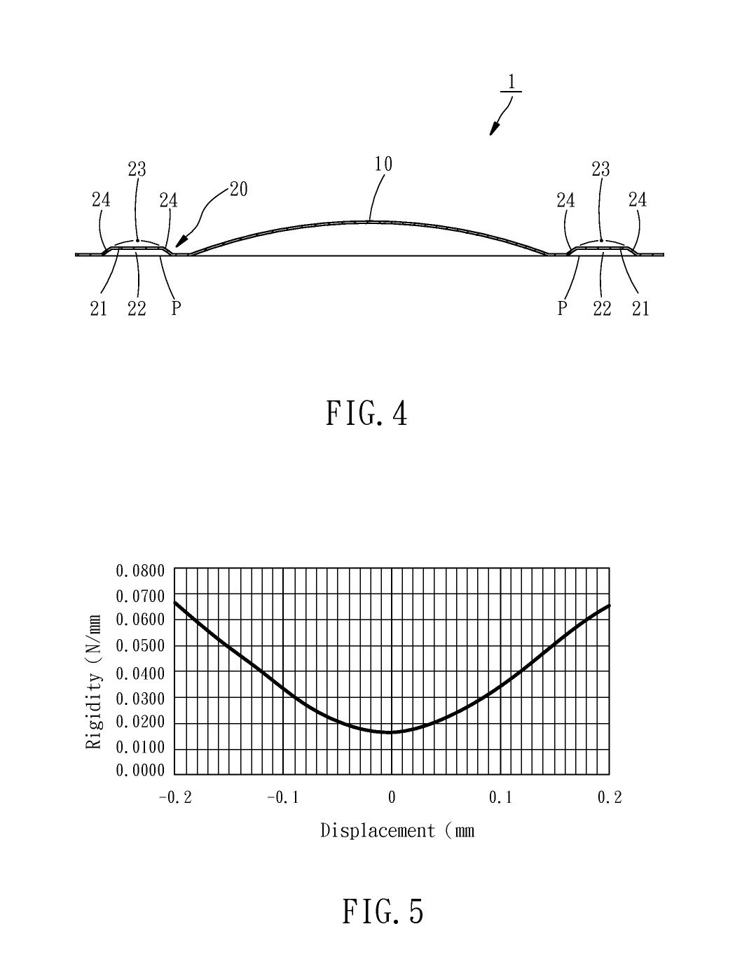

The central portion 10 is the primary sounding component of the diaphragm 1 and located at the center of the diaphragm 1. The surround 20 is connected with and encircles an external edge of the central portion 10 for connecting the central portion 10 to a housing of the speaker. The surround 20 includes a concavity 22 and an action protrusion 20A having an arc-shaped section. Referring to FIG. 4, an external peripheral edge of the central portion 10 and a lower bottom end of the concavity 22 jointly define an imaginary datum plane P and two ends of an external side of the action protrusion 20A extend away from the datum plane P to intersect with each other to define an imaginary end point 23. The action protrusion 20A further includes an annular flexible portion 21 located between the end point 23 and the datum plane P and encircling the central portion 10. Further, the action protrusion 20A includes two arc-shaped portions 24 symmetrically located at two sides of the annular flexible portion 21. In this embodiment, the annular flexible portion 21 is provided with a tabular section and substantially parallel to the datum plane P. In addition, the arc-shaped portions 24 and the annular flexible portion 21 are connected discontinuously.

When a simulation is applied to the first preferred embodiment of the present invention, the relationship between the rigidity of the diaphragm 1 and the displacement of the central portion 10 is shown in FIG. 5, in which the curve illustrating the relationship is centered on the zero of the X-axis to have symmetrically left and right parts. As illustrated in FIG. 5, the annular flexible portion 21 indeed changes the whole acoustic compliance of the diaphragm 1 and decreases the difference between the upward and downward displacement of the central portion 10 to make the speaker output the sound of approximately the same acoustic pressure to further improve the potential acoustic distortion and noise.

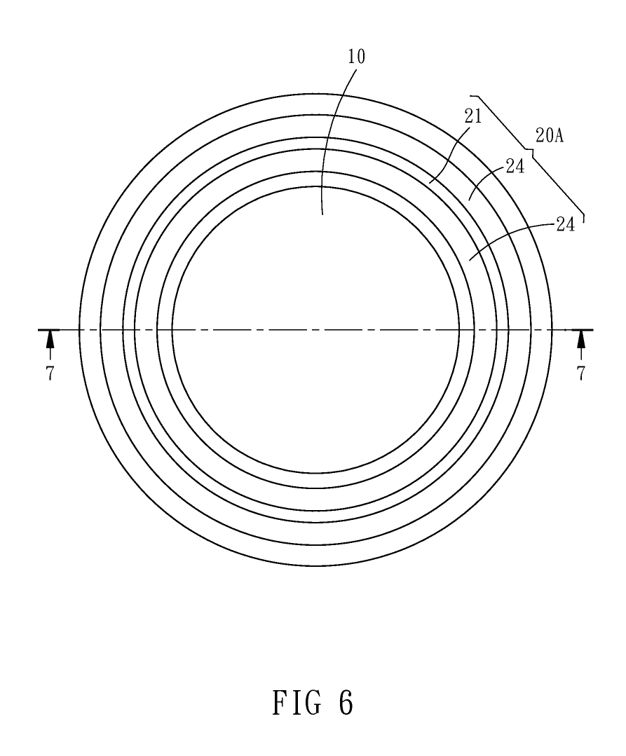

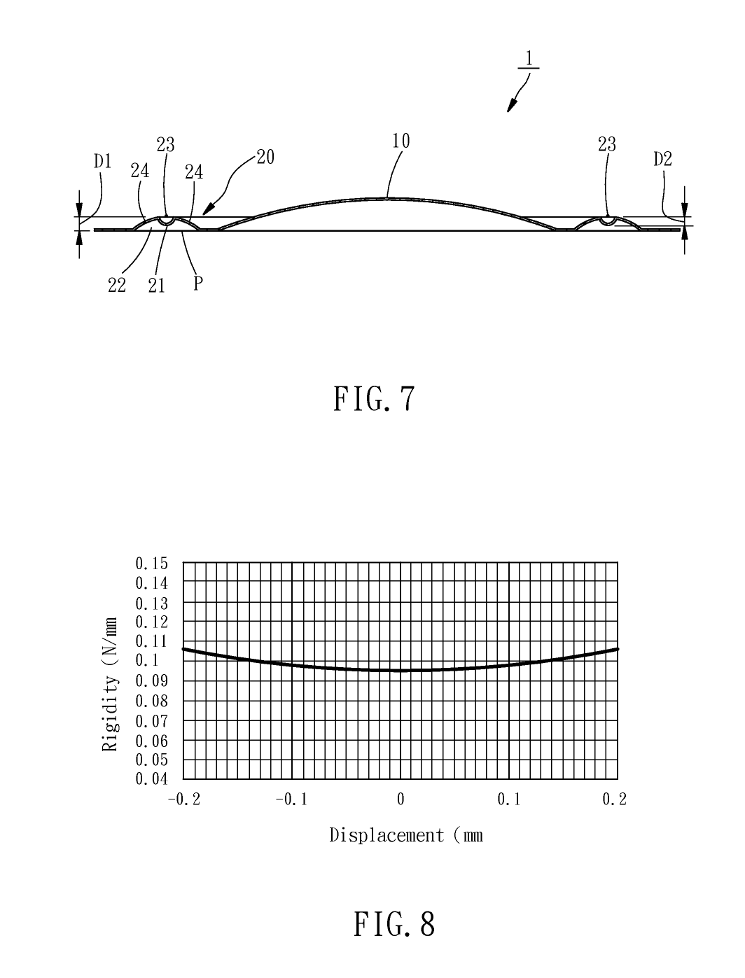

Referring to FIGS. 6-8, a diaphragm 1 constructed according to a second preferred embodiment of the present invention is structurally similar to that of the first preferred embodiment, having the following difference. The annular flexible portion 21 is arc-shaped in sectional view, e.g. the annular flexible portion 21 is recessed downward from a center of a top edge of the action protrusion 20A. In addition, the depth D2 of the annular flexible portion 21 is half of the depth D1 of the surround 20. The same simulation applied to the second preferred embodiment of the present invention is illustrated in FIG. 8, in which the left and right parts of the curve centered on the zero of the X-axis are approximately symmetric and thus the same effect can be reached.

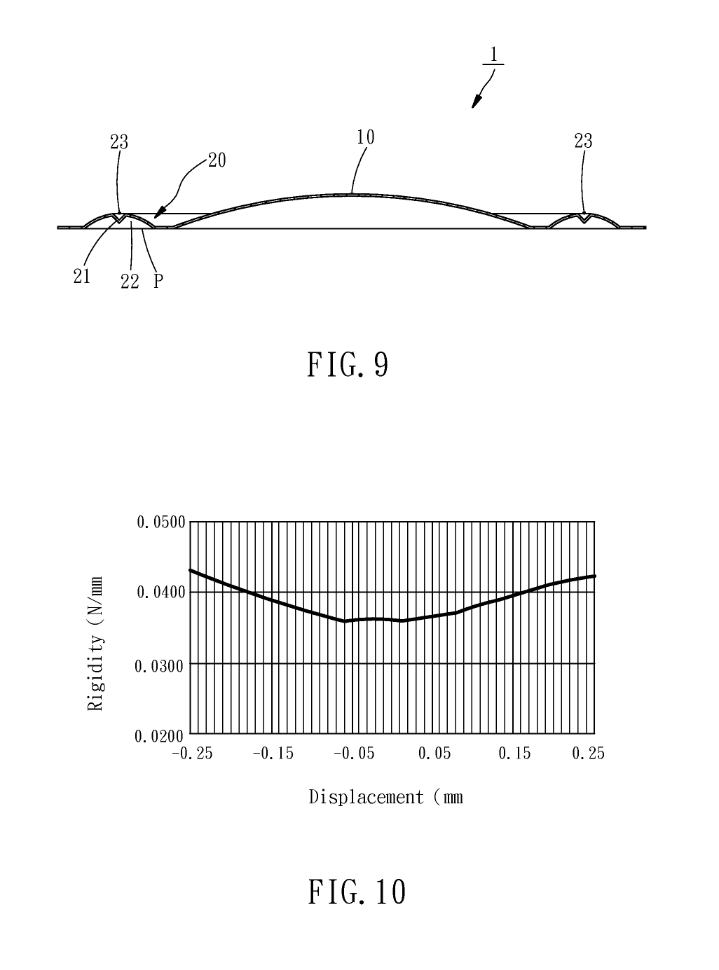

Referring to FIGS. 9 and 10, a diaphragm of a third preferred embodiment of the present invention is structurally similar to that of the second preferred embodiment, having the following difference. The section of the annular flexible portion 21 is triangular. The same simulation applied to the third preferred embodiment of the present invention is illustrated in FIG. 10, in which the left and right parts of the curve centered on the zero of the X-axis are approximately symmetric and thus the same effect can be reached.

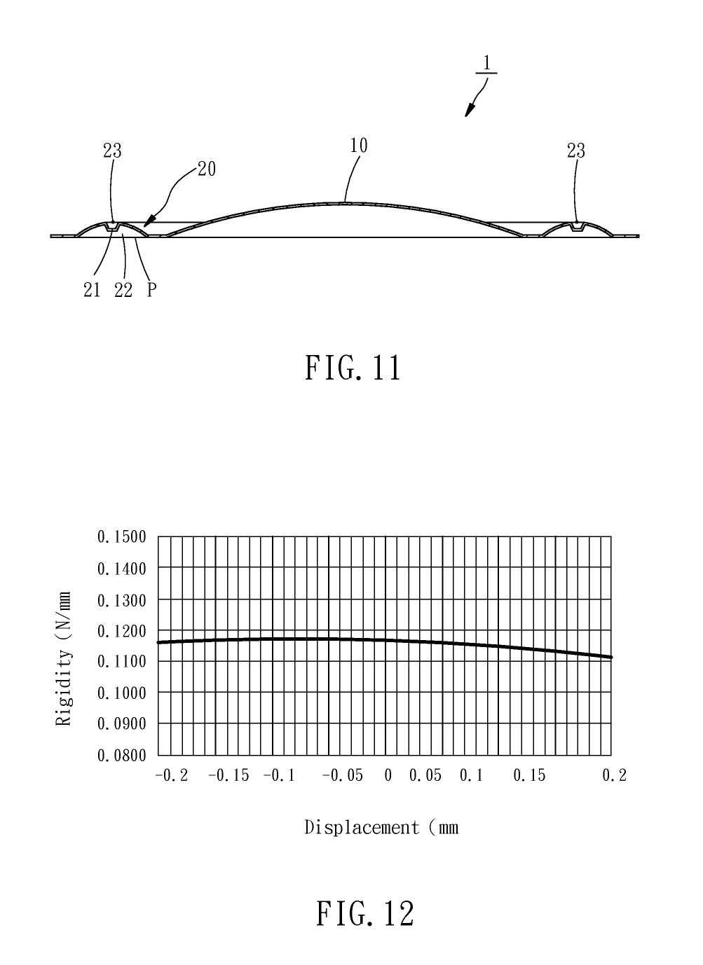

Referring to FIGS. 11 and 12, a diaphragm of a fourth preferred embodiment of the present invention is structurally similar to that of the second preferred embodiment, having the following difference. The section of the annular flexible portion 21 is trapezoid-shaped. The same simulation applied to the fourth preferred embodiment of the present invention is illustrated in FIG. 12 and concludes that the difference between the upward and downward vibrations of the central portion 10 is very little.

What is claimed is:

1. A diaphragm comprising:
a central portion; and
a surround encircling and connected with the central portion, the surround having a symmetric action protrusion protruding upward, an imaginary datum plane being defined jointly by a peripheral edge of the surround and a lower bottom end of the action protrusion, the action protrusion having two arc-shaped portions and a flexible portion connected between the two arc-shaped portions, wherein the flexible portion is provided with a tabular section.

2. The diaphragm as defined in claim 1, wherein the flexible portion encircles the central portion.

3. The diaphragm as defined in claim 1, wherein the flexible portion is parallel to the datum plane.

4. A diaphragm comprising:
a central portion; and
a surround encircling and connected with the central portion, the surround has a symmetric action protrusion protruding upward, an imaginary datum plane being defined jointly by a peripheral edge of the surround and a lower bottom end of the action protrusion, the action protrusion having two arc-shaped portions and a flexible portion connected between the two arc-shaped portions, wherein the flexible portion being recessed downward from a center of a top edge of the action protrusion, a bottom edge of the flexible portion being located between the action protrusion and the datum plane.

5. The diaphragm as defined in claim 4, wherein the flexible portion encircles the central portion.

6. The diaphragm as defined in claim 4, wherein the flexible portion is provided with an arc-shaped, trapezoid-shaped, or triangular section.

7. The diaphragm as defined in claim 6, wherein the flexible portion is provided with a depth that is half of that of the surround.
